(19) United States
(12) Patent Application Publication
(10) Pub. No.: US 2005/0124347 A1
(43) Pub. Date: Jun. 9, 2005

(54) Method and apparatus for congestion control in high speed wireless packet data networks

(76) Inventor: Patrick A. Hosein, San Diego, CA (US)

Correspondence Address: COATS & BENNETT, PLLC, P O BOX 5, RALEIGH, NC, 27602, US

(21) Appl. No.: 10/992,271

(22) Filed: Nov. 18, 2004

Related U.S. Application Data
(60) Provisional application No. 60/527,358, filed on Dec. 5, 2003.

(51) Int. Cl. H04B 15/00

(52) U.S. Cl. 455/446; 455/562.1; 455/561

(57) ABSTRACT

Serving sector selection decisions are made by or for a mobile station (MS) operating in a wireless communication network based on predicting forward and/or reverse link data throughputs for one or more non-serving sectors and comparing the expected throughput(s) to expected or actual throughput(s) of the MS's current serving sector. In one embodiment, the MS receives per-sector resource information supporting throughput predictions, and uses that information and its per-sector channel quality measurements to predict expected throughputs for one or more candidate sectors. It generally changes to the sector offering the highest expected data throughput, but the MS can qualify that decision to avoid too-frequent switching. In another embodiment, the MS sends per-sector channel quality information to the network and the network selects the mobile station's sector based on predicted throughputs. In another embodiment, the network performs throughput prediction processing but sends the predictions to the MS for selection decision processing.

### RELATED APPLICATIONS

This application claims priority under 35 U.S.C. § 119(e) from U.S. provisional application Ser. No. 60/527,358 filed on 5 Dec. 2003, which is expressly incorporated in its entirety by reference herein.

### BACKGROUND OF THE INVENTION

The present invention generally relates to wireless communication networks, and particularly relates to facilitating the selection of a serving sector for a mobile station operating in such networks.

Wireless communication networks based on the IS-2000 family of standards make use of a shared packet data channel to provide forward link packet data services at high rates to a plurality of mobile stations. Generally, the packet data channel in each sector carries data for each of the mobile stations being served by that sector, and the data rates used to serve each mobile station typically are a function of the reserve power available for allocation to the shared packet data channel, the number of reserve spreading codes available for encoding the shared packet data channel, the number of mobile stations being served by the base station, and each mobile station's particular radio conditions. Other types of networks offer similar shared channels supporting high-rate services, such as the High Data Rate (HDR) channel defined for 1xEV-DO, and the High Speed Downlink Packet Access (HSPDA) channel defined by the Wideband CDMA (W-CDMA) standards.

One characteristic of high-rate service on these kinds of shared channels is that each mobile station autonomously selects the particular network sector to be used for serving it. By allowing autonomous serving sector selection, each mobile station can select the “best” one of the sectors that currently are candidates for serving it on the shared channel. Oftentimes, the candidate set of sectors comprises the mobile station's “active set” or “reduced active set.”

Mobile stations typically pick the best serving sector by comparing the signal strengths of pilot signals received from each sector in a set of sectors that are candidates for serving the mobile station, e.g., an “active set” of network sectors, which may be designated or controlled by the network. By selecting the sector offering the highest received signal strength from the set of candidate sectors, the mobile station ostensibly positions itself to be served at the highest possible rates and thereby obtain the highest data throughput.

As the mobile station's reception conditions change, it can “move” to another sector by signaling its selection of another sector in the candidate set as the new serving sector. While the mechanisms for doing so may vary by network type, IS-2000 networks use an exemplary mechanism for serving sector selection by individual mobile stations. According to the IS-2000 method, each mobile station being served on the shared channel provides channel quality feedback that is used by the network to set the serving data rate for the mobile station. Typically, mobile stations engaged in packet data service on the shared packet data channel provide such feedback to the network in the form of Channel Quality Indicator (CQI) reports sent at some defined rate, such as every 1.25 ms (800 Hz).

The mobile station “covers” its CQI reports with a (Walsh) coding corresponding to its current serving sector. When the mobile station wants to change to a new serving sector, it begins alternately covering its CQI reports with a (Walsh) coding corresponding to the target sector. At some time later, the mobile station switches over to the shared packet data channel of the target sector, which is now the new serving sector, and the network begins transmitting forward link data for the mobile station on the new serving sector's shared packet data channel. In supporting the changeover, the network stops transmitting the mobile station's packet data on the prior serving sector's shared channel, and begins transmitting that packet data on the packet data channel of the newly selected serving sector. Delays in the changeover can be signaled to the mobile station, allowing it to “synchronize” to the start and end of packet data transmission on the shared packet data channels in the old and new serving sectors.

Allowing mobile stations to select (and reselect) serving sectors dynamically in the above manner allows individual ones of the mobile stations to pick the sectors offering them the best signal quality. However, simply picking the sector corresponding to the best received signal quality at the mobile station does not necessarily ensure that the mobile station gets the best possible shared channel service because the throughput with which the mobile station is served on a given sector's shared channel depends on a number of factors, such as the sector's transmission power level, congestion level, number of users, and bandwidth. Thus, a highly congested sector may not serve the mobile station at as high a rate as a less congested sector, even though it can provide a stronger received signal at the mobile station.

Further, since the mobile stations select their serving sectors autonomously, a conventional network has no mechanism to “shed” shared mobile stations from a congested sector, or any mechanism to prevent additional mobile stations from selecting an already overcrowded sector. Consequently, the conventional network is left without any direct ability to perform “load balancing” wherein the mobile stations are capable of departing a congested sector and advantageously selecting a sector capable of providing greater throughput.

### SUMMARY OF THE INVENTION

The present invention comprises a method and apparatus for selecting the serving sector of a mobile station for packet data service based on predicting the packet data throughput expected for one or more candidate sectors. In one embodiment, the network transmits per-sector resource information to the mobile station, and the mobile station uses that information in conjunction with the mobile station's per-sector channel quality/strength measurements to predict the expected data throughput to the mobile station for each candidate sector under serving sector selection consideration. In one or more embodiments, the per-sector resource information relates to each sector's shared packet data channel, such as the transmit power and spreading code resources currently available for that sector's shared packet data channel. The mobile station uses the received information in conjunction with its per-sector channel quality measurements to predict the expected data throughputs to the mobile station for each sector, and makes its sector selection decision by comparing the predicted throughput(s) to the predicted or actual (measured) throughput for its current serving sector.

In another embodiment, the mobile station provides per-sector channel quality information to the network. The network uses that information in conjunction with the sector resource information, which is known to it, to predict the expected data throughput to the mobile station for one or more of the mobile station's candidate sectors, i.e., for one or more of the radio sectors that currently are available for selection by the mobile station as the forward link serving sector for high-rate packet data services to the mobile station. The per-sector resource and channel quality information may be shared between radio base stations, also known as base transceiver stations, allowing them to perform the throughput predictions, or the information may be sent from them to a centralized processing circuit, such as a base station controller, for centralized processing in support of throughput prediction.

In one embodiment, the network uses the predicted throughputs to select the mobile station's serving sector, and sends sector selection directives as needed to the mobile station. In another embodiment, the network sends the throughput prediction information to the mobile station, leaving the sector selection decision processing up to the mobile station. In that embodiment, the mobile station uses the throughput predictions received from the network to identify the “best” serving sector, and signals sector selection changes to the network as needed.

Generally, the network includes base stations having one or more transceiver circuits providing sectorized radio coverage. In one embodiment, the mobile stations use sector-specific information provided by the base station to predict the estimated data throughput for each sector in a candidate set. The base station includes one or more resource preprocessing circuits configured to detect and consolidate power and coding resource information for each sector of the base station system. This sector resource information relates at least to the sector's shared forward link packet data channel, but may advantageously relate to reverse link channels as well, thus allowing sector selection based on throughput predictions for both the forward and reverse links.

In an exemplary embodiment, the base station transmits the sector resource information in the form of pre-calculated parameters. In one embodiment, the sector resource information comprises data relevant to predicting throughput on the sector's shared packet data channel, including the amount of transmit power and spreading code resources available for the channel and, optionally, information identifying the type of service scheduler being used by that sector for the shared packet data channel. These parameters may be periodically broadcast in each sector.

A complementary mobile station adapted for use with one or more embodiments of the present invention comprises radio frequency transceiver circuits to send and receive signals on the wireless communication network. In addition, the mobile station has one or more processor circuits configured to predict a throughput for sectors among a set of sectors in the network that are candidates for serving the mobile station on the packet data channel. The mobile station predicts expected sector throughput for one or more of the candidate sectors based on the received sector resource information and corresponding channel quality information, which can be estimated at the mobile station based on candidate sector pilot strength, for example. Thus, the mobile station may evaluate the predicted throughput for two or more of the sectors in the set and select a new serving sector if the predicted throughput for the new serving sector is higher than the actual or predicted throughput for a current serving sector.

The mobile station may be configured to qualify the switching decision by requiring that the expected throughput predicted for a candidate sector be higher than the actual or predicted throughput of the current serving sector by a predetermined amount—i.e., better by a defined margin. Further, the mobile station may be configured to select a new serving sector based on predicting expected data throughput for its reverse link(s). Thus, the sector selection decision can be based on determining that one or both the forward and reverse link data throughputs are expected to be higher in one of the candidate sectors.

In comparing predicted throughputs, the mobile station may be configured to compare an actual throughput of the current serving sector to predicted throughputs for non-serving sectors in the candidate set. Alternately, the mobile station may be configured to predict a throughput for the current serving sector for comparison to that of the non-serving sectors. Actual throughput numbers may be used to fine-tune the prediction algorithm to improve the accuracy of the predicted values. The prediction algorithm also takes into consideration the attenuation of throughput that arises should a mobile station join a new non-serving sector. That is, when the mobile station predicts what its throughput will be for a given candidate sector, the effects of adding the mobile station to that candidate sector are considered.

In another embodiment, the mobile stations still make sector selection decisions based on predicted throughputs, but the throughput prediction processing is carried out by the network and the results transmitted to the mobile stations for evaluation. Thus, the sector resource information from each sector in the candidate set and the channel/signal quality information from the mobile station for those candidate sectors are sent to a network entity configured for the desired throughput prediction processing. Such an entity may comprise a central processing location, such as a base station controller that is communicatively coupled to one or more radio base stations providing the serving and candidate sectors.

Once the network makes the throughput predictions, that information can be transmitted to the mobile stations for their evaluation in autonomous sector selection processing. Alternatively, for each given mobile station, the network may proceed to make a serving sector decision and transmit a directive to the mobile station instructing it to switch to a particular serving sector.

Of course, other selection decision algorithms may be adopted as needed or desired, and it should be understood that the present invention is not limited to the above features and advantages. Indeed, those skilled in the art will recognize additional features and advantages upon reading the following detailed discussion, and upon viewing the accompanying figures.

### BRIEF DESCRIPTION OF THE DRAWINGS

FIG. 1 is a diagram of an exemplary wireless communication network according to one or more embodiments of the present invention;

FIG. 2 is a diagram of mobile station circuit details for an exemplary mobile station according to one or more embodiments of the present invention;

FIG. 3 is a diagram of radio base station and base station controller circuit details for an exemplary base station system according to one or more embodiments of the present invention;

FIG. 4 is a diagram of exemplary per-sector transmission of sector resource information according to one or more embodiments of the present invention;

FIG. 5 is a diagram of exemplary network processing logic to implement the per-sector transmission of sector resource information according to one or more embodiments of the present invention; and

FIG. 6 is a diagram of exemplary mobile station processing logic to implement sector selection based on throughput prediction according to one or more embodiments of the present invention.

### DETAILED DESCRIPTION OF THE INVENTION

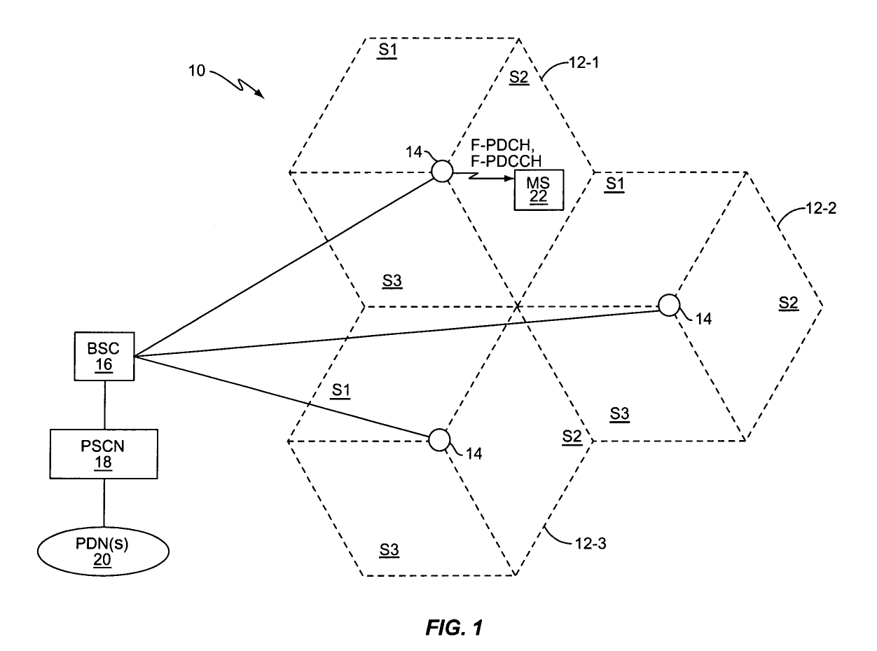

The present invention provides a method and apparatus for serving sector selection based at least in part on predicting an estimated throughput for one or more radio sectors that are candidates for selection. In that context, FIG. 1 partially illustrates an exemplary wireless communication network 10. Network 10 may comprise, for example, a cellular communication network based on the IS-2000 standards, or based on the W-CDMA standards. As illustrated, network 10 comprises a Radio Access Network (RAN) including Radio Base Stations (RBSs) 14 and a Base Station Controller (BSC) 16, and a Packet Switched Core Network (PSCN) 18, which communicatively couples network 10 to one or more Public Data Networks (PDNs) 20, such as the Internet. Those skilled in the art will appreciate that network 10 may include additional entities that are not illustrated for clarity.

Network 10 provides radio coverage organized as a plurality of radio cells 12-1, 12-2, and 12-3, with each cell providing three sectors S1, S2, and S3, of radio coverage. Note that for convenience of discussion, this disclosure focuses on “sectors” as the basic area of radio coverage, but those skilled in the art should appreciate that the same concepts can be applied at varying levels, including for example, at the per-cell level. A mobile station 22 operating within the network's coverage area generally can receive signals from more than one sector, and the mobile station's return radio signals generally can be received by network 10 at more than one sector.

In an IS-2000 embodiment of network 10, one may assume that the illustrated mobile station 22 is engaged in high-rate packet data services, and thus is being served on the Forward Packet Data Channel (F-PDCH) from one of the sectors in the mobile station's currently designated “active” set of sectors. In a W-CDMA embodiment of network 10, a similar service scenario applies but involves the HSPDA channel.

While active set designation as performed by network 10 may vary depending on the wireless standard embodied by network 10, such active sets generally are based on identifying the RBS sectors capable of transmitting to the mobile station 22 at or above a defined signal strength. In one or more embodiments, the mobile stations 22 autonomously select the network sector through which they wish to receive and transmit packet data transmissions, and the base station 14 influences that sector selection by transmitting sector resource information to the mobile station 22 on a per sector basis.

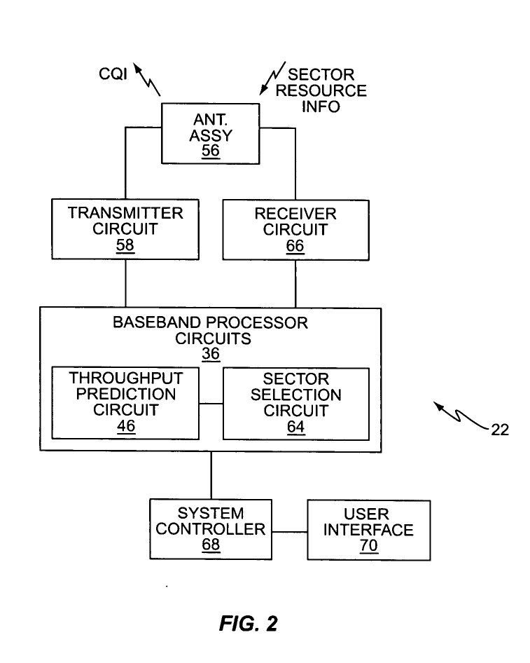

An exemplary mobile station, such as that shown in FIG. 2, uses the sector resource information to predict an estimated throughput for each sector in one or both of a forward and reverse link channel. More particularly, the illustrated mobile station 22 comprises an antenna assembly 56, RF receiver and transmitter circuits 58 and 66, respectively, baseband processing circuit(s) 36, which includes or is associated with a channel throughput prediction circuit 46 and a sector selection circuit 64, a system controller 68, and a user interface 70.

The throughput prediction circuit 46 calculates an estimated throughput for each potential serving sector in a candidate set using sector resource information received relating to each of those sectors. The sector selection circuit 64 evaluates the estimated throughputs predicted by the throughput prediction circuit 46 and selects an appropriate serving sector, which may be the current serving sector, in an effort to maximize throughput. Those skilled in the art will appreciate that mobile station 22 may comprise a cellular radiotelephone, a wireless pager, a Portable Digital Assistant, a laptop/palmtop computer with wireless communication capability, or essentially any other type of portable communication device, and that its particular arrangement of circuits and features will depend on its particular use or purpose.

Further, those skilled in the art should appreciate that the illustrated circuits may comprise hardware, software, or any combination thereof. For example, the throughput prediction circuit 46 and sector selection circuit 64 may be separate hardware circuits, or may be included as part of other processing hardware. More advantageously, however, the throughput prediction circuit 46 and sector selection circuit 64 are at least partially implemented via stored program instructions for execution by one or more microprocessors, Digital Signal Processors (DSPs), or other digital processing circuit included in mobile station 22.

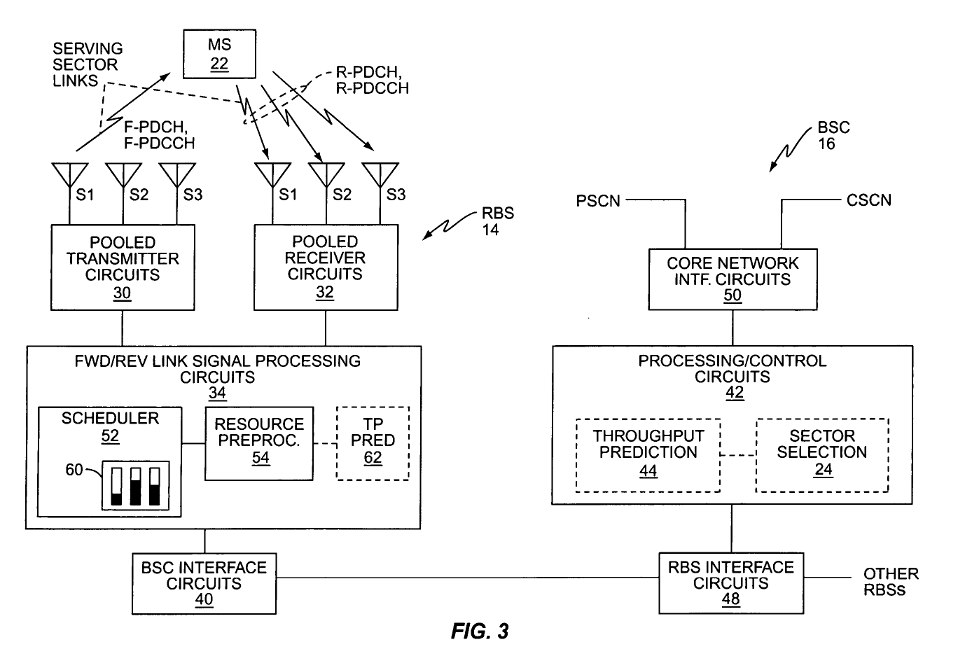

FIG. 3 illustrates an exemplary RBS 14 and BSC 16 in accordance with the present invention. RBS 14 provides sectorized transmit and receive coverage supporting the mobile station 22 in the above network implementation 10. The illustrated RBS 14 comprises pooled transmitter circuits 30, pooled receiver circuits 32 (i.e., transceiver circuit resources), forward/reverse link signal processing circuits 34, and BSC interface circuits 40. The illustrated BSC 16 includes complementary RBS interface circuits 48 as well as core network interface circuits 50 for communication with packet-switched and/or circuit switched core networks.

The RBS 14 transmits high-rate packet data to the mobile station 22 on the forward link from one sector—i.e., a current serving sector—but typically receives reverse link transmissions from the mobile station 22 at multiple sectors. In an IS-2000 based implementation, RBS 14 transmits forward link packet data to the mobile station on the serving sector's F-PDCH and associated control information on the serving sector's Forward Packet Data Control Channel (F-PDCCH), but typically receives reverse link packet data on the mobile station's Reverse PDCH (R-PDCH) and associated control signaling on the mobile station's Reverse PDCCH (R-PDCCH) at multiple sectors.

The forward/reverse link signal processing circuits 34 of RBS 14 include a F-PDCH scheduler 52 and a resource preprocessing circuit 54. The scheduler 52 monitors pooled resource information 60 corresponding to a variety of resources and/or usage conditions, such as the number of current users, transmit power availability, spreading code availability, and congestion information related to the ratio of possible and actual throughput rates on the F-PDCH. This pooled resource information 60 is used in one or more invention embodiments discussed herein to predict packet data channel throughput. The resource preprocessing circuit 54 performs some initial processing (described more thoroughly below) of the pooled resource information 60 in preparation for throughput prediction and evaluation. The illustrated forward/reverse link signal processing circuits 34 may comprise hardware, software, or any combination thereof. In an exemplary embodiment, some of the network-based sector throughput prediction and transmission processing may be implemented as program instructions for execution by one or more microprocessors, or other logic processing circuits, implemented in RBS 14.

The scheduler 52 performs a scheduling function to allocate time during which the RBS 14 transmits packet data to individual mobile stations 22 on the F-PDCH. A variety of scheduling schemes may be implemented, including round robin scheduling, proportionally fair scheduling, and maximum throughput scheduling (also referred to as “Max Carrier-to-Interference Ratio” or Max C/I scheduling). With proportionally fair scheduling, the RBS 14 attempts to establish a substantially constant ratio of achievable data throughput and averaged served rate for each mobile station 22 being scheduled on the F-PDCH by the RBS 14.

In general, the scheduler 52 considers some or more of the variables in the pooled resource information 60 in performing its scheduling function, including the amount of sector transmit power available for transmitting on the F-PDCH, which varies as a function of the number of voice and low-rate data users being served on the sector via dedicated (non-shared) channels, the number of spreading codes available for multi-coding the F-PDCH, which also varies as a function of the number of spreading codes being used for the dedicated user, broadcast, and control channels being transmitted in the sector.

In accordance with the present invention, information about these pooled resources 60 may also be used to predict an estimated throughput from an RBS 14 to a mobile station 22 on a F-PDCH. As indicated in FIG. 2, this prediction is performed in the present embodiment by the throughput prediction circuit 46 of mobile station 22. The sector resource information is distributed to the mobile stations 22 via broadcast or targeted messages on one or both of the F-PDCH and F-PDCCH. For ease of transmission, processing, and prediction, the sector resource information may be consolidated by the resource preprocessing circuit 54 (see FIG. 3) into one or more parameters.

As previously discussed, one embodiment of the RBS 14 uses a proportionally fair scheduler 52, where the ratio of a mobile station's average packet data link throughput and average served rate approaches some constant. For a particular mobile station i, this ratio can be expressed as

$$θ = \frac{{r}_{i}}{{d}_{i}}$$

where rᵢ is the average forward link throughput for each mobile station 22 and represents an actual throughput for a given mobile station i. The term dᵢ is the average served rate. In the 1xEV-DO standard, this term represents a rate requested by a mobile station 22. In the 1xEV-DV standard, this term represents a theoretically achievable rate based at least partly on the channel quality for that mobile station 22. In one or more embodiments, the present invention seeks to predict an estimated value for rᵢ so the above equation can be represented as:
rᵢ=θ·dᵢ

Although the ratio θ approaches a constant value for all mobile stations 22 being served on the F-PDCH in a given radio sector, its value nevertheless changes as operating conditions change. For instance, the value of θ may change as new transmission frames are delivered and, importantly, as new mobile stations 22 are added to the sector. If this ratio is expressed as an indexed quantity θ(k), an updated estimate of θ may be calculated using the equation

$$θ ( k ) = ϕ θ ( k - 1 ) + ( 1 - ϕ ) \cdot \frac{r ( k )}{d ( k )}$$

where φ represents a weighting factor that attributes more or less weight to a previous value of θ as compared to a present value for the ratio r/d. Accordingly, θ(k) provides a present estimate of θ, but the addition of a new user to the cell/sector will cause this metric to change further.

Where schedule 52 operates as a proportionally fair scheduler, it can be shown that the throughput on the F-PDCH for an individual mobile station 22 varies with the number of users in the system by the factor g(N) given by

$$g ( N ) = {\int }_{0}^{∞} x {{ⅇ}^{- x} ( 1 - {ⅇ}^{- x} )}^{N - 1} ⅆ x$$

where the variable x is at least partly based on channel noise characteristics. A thorough description of the above equation for g(N) and the variable x is provided in the publication entitled, “A TCP-Friendly Congestion Control Algorithm for 1XEV-DV Forward Link Packet Data” by P. Hosein in Proceedings of IEEE Vehicular Technology Conference, Spring 2003, Jeju, Korea, 2003, which is expressly incorporated in its entirety by reference herein.

If a mobile station 22 switches to a new serving sector, the F-PDCH throughput of the new serving sector consequently decreases due to the addition of a new mobile 22 station to that sector's F-PDCH. Again, where a proportionally fair scheduler 52 is used, the amount of this decrease can be expressed as

$$γ ( N ) = \frac{g ( N + 1 )}{g ( N )}$$

where γ(N) represents an attenuation factor. By comparison, the attenuation factor for a round-robin type scheduler is

$$γ ( N ) = \frac{N}{N + 1}$$

which is simply a ratio of the existing number of mobile stations 22 being scheduled on the F-PDCH to the new number of mobile stations 22, which increases by 1 with the addition of a mobile station 22 newly selecting that sector. In general, however, the diversity gain of a proportionally fair scheduler increases with the number of users. Thus, the attenuation factor decreases at a slower rate compared to that of a round robin scheduler. Stated another way, the round robin scheduler is more detrimentally affected by the addition of a new user as compared to a proportionally fair scheduler.

Having determined a present estimate of the ratio θ and the attenuation factor γ, an accurate estimate of ratio θ produced by the addition of a new mobile station to a sector may be expressed as the product of these two terms. In other words,
rᵢ=θ(k)·γ(N)·dᵢ
which leaves one to predict the estimated served rate dᵢ for the mobile station 22, which is the expected value of the rate at which the mobile station 22 would be served in the target sector.

In information theory, Shannon's Capacity Theorem predicts the maximum information transfer rate in a communications channel. The theorem states that the maximum amount of error-free digital data that can be transmitted over a communications link with a specified bandwidth in the presence of noise interference is provided by

$$C \leq B \cdot {log}_{2} ( 1 + \frac{S}{N} )$$

where C is the capacity in bits per second, B is the raw channel bandwidth in hertz, and S/N is the signal to noise ratio of the signal expressed as a straight power ratio (not in decibels). As modified for use in the present invention, Shannon's Capacity Theorem may be expressed as

$${d}_{i} = W \cdot B \cdot {log}_{2} ( 1 + \frac{P \cdot q}{W \cdot p} )$$

where dᵢ is again, the estimated served rate, W is the number of Walsh codes available for use in the F-PDCH, and B is the channel bandwidth. Thus, the W*B term represents the total bandwidth available for the F-PDCH. Variable P is the available transmission power assigned by the RBS 14 to the F-PDCH, and p is the transmission power of a pilot signal for the corresponding sector, (i.e., the strength of the sector's F-CPCCH signal). The final variable q is the measured pilot signal strength seen at the mobile station 22. Thus, the ratio q/p represents the attenuation of the pilot signal, which provides a measurable indication of the channel quality. This channel quality is also expressed as a channel quality indicator (CQI) that is generated by each mobile station 22 and transmitted on the R-CQICH as an indicator of pilot strength. In this embodiment of the present invention, q represents a quantity actually calculated by the individual mobile stations 22. The remaining variables are determinable at the RBS 14 level.

Since P is the available transmission power assigned by the RBS 14 and the channel attenuation is known, then the term P*(q/p) represents the strength of the F-PDCH signal at the mobile station 22. Further, where W is the number of Walsh codes used for the F-PDCH, the power received per Walsh code is given by the term Pq/Wp, which is the term used to represent the S/N ratio in Shannon's Capacity Theorem above and below.

Expressing the predicted throughput as a combination of the predicted ratio θ and predicted served rate dᵢ yields

$${r}_{i} = θ ( k ) \cdot γ ( N ) \cdot W \cdot B \cdot {log}_{2} ( 1 + \frac{P \cdot q}{W \cdot p} ) ≡ α {log}_{2} ( 1 + β \cdot q )$$

where the parameters α and β have been substituted according to

$$α = θ ( k ) \cdot γ ( N ) \cdot W \cdot B \& β = \frac{P}{W \cdot p} .$$

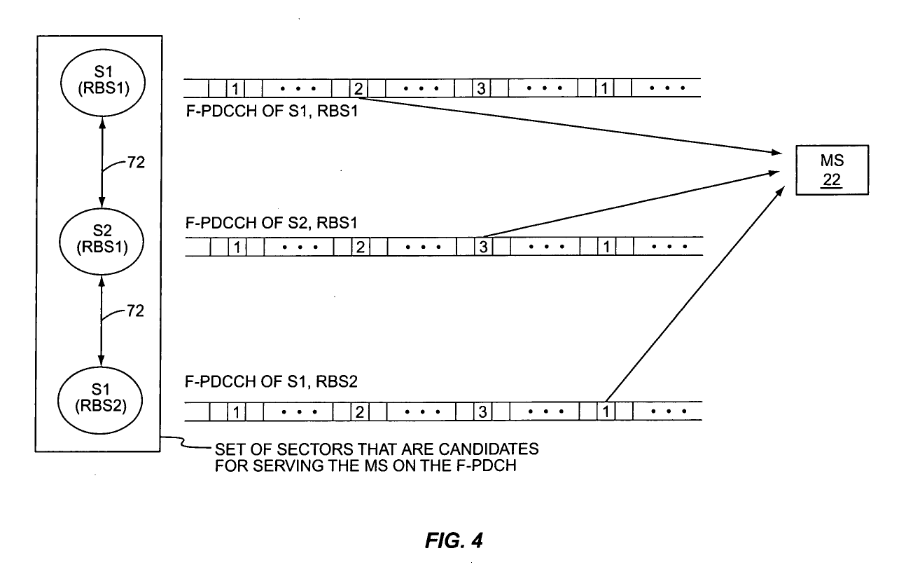

These parameters α and β are RBS 14 specific and account for information that is relevant to shared packet data channel throughput. These parameters may calculated by the resource preprocessing circuit 54 shown in FIG. 3 and disseminated by the RBSs 14 as previously described (see also the more comprehensive discussion below relating to FIG. 4). Consequently, each mobile station 22 can use these parameters to determine its predicted throughput if it were to move to another sector or cell 12. The mobile station 22 may or may not determine a predicted throughput for its current serving sector. For example, it could simply compare its actual average throughput to the predicted throughput of non-serving sectors.

However, it may be desirable to predict throughput for the current serving sector for comparison to an actual throughput to fine-tune the prediction algorithm. Since it is contemplated that α and β are broadcast periodically, each mobile station 22 can periodically determine which serving sector can potentially provide the greatest throughput. If this “best” serving sector is the current serving sector, nothing is done. However, if the “best” serving sector is a non-serving sector, and a number of selection-limiting safeguards are satisfied, the mobile station 22 can proceed to change sectors using the aforementioned sector selection processing.

Certain selection-limiting safeguards may be implemented to discourage excessive sector switching because of the signaling overhead produced. One safeguard is to permit switching only when the predicted throughput of a non-serving sector exceeds that of the serving sector by a significant, predetermined amount. For instance, switching may be initiated when the predicted throughput of a non-serving sector exceeds that of the serving sector by 5 to 10 percent. Another safeguard is to temporarily remove the previous sector from the candidate set immediately after a switch to delay any switchback to the previous sector. It may also be desirable to allow serving sector changes only where both the forward and reverse link throughputs are improved, or at least are predicted to improve, by the contemplated sector switching, since link asymmetry may otherwise result.

In an alternative embodiment of the present invention, a single parameter α′ may be used to estimate predicted throughputs if it is assumed that mobile stations typically switch near a sector boundary. With this assumption, the channel quality q becomes small and the expression log₂(1+x) can be approximated simply as x. Hence,

$${r}_{i} = θ ( k ) \cdot γ ( N ) \cdot B \cdot \frac{P \cdot q}{p} ≡ α \cdot β \cdot q ≡ {a}^{′} \cdot q$$

which means α′ is the only parameter that is calculated by the throughput prediction processing circuit 54 and broadcast by RBS 14. This particular approach tends to assign greater weight to the channel quality q of a mobile station 22 and may be preferable in certain situations, such as in highly congested or noisy conditions.

FIG. 4 illustrates an exemplary basis for disseminating information from the network to the mobile stations 22 in support of their throughput prediction processing. Such information can include the sector resource parameters α, β, and α′. In an IS-2000 embodiment, each sector of RBSs 14 independently transmits its load information over the F-PDCCH being transmitted in that sector. The sector resource information for each sector is sent periodically in available slots as a broadcast message that all mobile stations 22 can monitor. Alternatively, the sector resource information may be distributed among other sectors via the backhaul connections 72 so that each sector places its own information and the information from other sectors into a targeted F-PDCCH message directed to a specific mobile station 22. In yet another embodiment, the sector resource information is distributed among other sectors via the backhaul connections 72 and each sector places that information in available slots in the F-PDCCH broadcast message. Still another embodiment contemplates distributing sector resource information among sectors via the backhaul connections. Each sector then broadcasts this information to the mobile stations 22 in the sector via the F-PDCH with a corresponding identifier in the associated F-PDCCH message. For example, a Medium Access Control (MAC) identifier can be sent on the F-PDCCH to indicate that a slot on the F-PDCH is being used to transmit sector information in support of throughput prediction at the mobile stations 22, or to transmit the throughput predictions themselves if the network 10 carried out the prediction processing, or to transmit sector selection directives if the network made the predictions and the sector selection decisions.

However, at least one embodiment of the present invention generally leaves the mobile station 22 free to select the F-PDCH serving sector based on the mobile station's autonomous processing. The network 10 influences that decision processing by providing the mobile station 22 with sector resource information that enables the throughput prediction circuit 46 of mobile station 22 to predict data throughput for one or more candidate sectors.

In contrast, as noted above, one or more embodiments of the present invention performs prediction, evaluation, and/or sector selection processing in the network 10. For instance, as indicated by the dashed blocks in FIG. 3, throughput prediction may also be performed in an optional throughput prediction circuit 62 at the RBSs 14 or in an optional throughput prediction circuit 44 of BSC 16, or cooperatively across some combination thereof. It should be understood that these circuit elements may be modified or omitted in dependence on how much throughput prediction processing is implemented at the RBS 14, the BSC 16, and at the mobile station 22.

In one alternative embodiment, BSC 16 comprises processing and control circuits 42, which include or are associated with a channel throughput prediction circuit 44 and a sector selection circuit 24. The channel processing and control circuits 42 may be implemented in hardware, software, or some combination thereof. These BSC circuits 44, 24 may perform substantially similar functions as throughput prediction circuit 46 and sector selection circuit 64 of mobile station 22 (see FIG. 2). That is, throughput prediction circuit 44 may predict estimated throughputs from individual radio sectors to individual mobile stations 22, and sector selection circuit 24 may perform sector selection based on an evaluation of the throughput predictions. Throughput prediction circuit 44 of BSC 16 needs the relevant sector resource information and channel quality information to calculate estimated throughputs. In such embodiments, the sector resource information (e.g., parameters α, β, or α′) is transmitted from the RBSs 14. Since the channel quality information q is based on received signal quality/strength measurements made at the mobile station 22 for the current serving and candidate sectors, e.g., for the mobile station's active set, such information generally is transmitted from the individual mobile stations 22 to the network 10.

By way of non-limiting examples, a given mobile station 22 can return channel quality information to the network 10 in support of network-based throughput prediction by sending high-rate CQI reports for the current serving sector and for one or more of the other candidate sectors. In some embodiments, sending COI reports for more than the current serving sector reduces the update rate of serving sector CQI reports because some of the periodic CQI reporting intervals are used to send non-serving sector reports. In other embodiments, the network 10 may rely on Periodic Pilot Strength Measurement Messages (PPSMMs) from the mobile stations 22 to gather signal quality information for the mobile station's non-serving sectors.

In any case, with the channel quality information from the mobile stations 22 and with the sector resource information on hand that is relevant to F-PDCH service—e.g., transmit power availability, spreading code availability, F-PDCH scheduler type, number of F-PDCH users, number of other users in the sector, etc.—the network 10 can make data throughput predictions in support of serving sector selection processing. The network 10 can make the selection decisions via sector selection circuit 24, and then broadcast those decisions to respective ones of the individual mobile stations 22 using an appropriate data channel, or it can transmit the throughput predictions to the mobile stations 22 and allow them to make the selection decisions.

In yet another embodiment, the throughput prediction processing is performed by a throughput prediction circuit 62 in RBS 14. The relevant sector resource information is readily available at the RBS 14 level from resource preprocessing circuit 54. Thus, the throughput prediction circuit 62 only needs to acquire channel quality information q from the various mobile stations 22. Once the prediction processing is completed at the RBS 14, this information can be distributed to sector selection circuit 64 in the mobile stations 22 or, alternatively, to sector selection circuit 64 in BSC 16. In this embodiment, the mobile stations 22 and BSC 16 are particularly suited to perform the serving sector selection because each has access to prediction information from a plurality of RBSs 14.

The alternative embodiments most recently described above rely on the RBS 14 or BSC 16 to perform throughput prediction. To that end, the channel quality parameter q is transmitted upstream to network 10. As noted earlier, each mobile station 22 generally provides a channel quality parameter in the form of a CQI for the current serving sector. However, the RBS 14 or BSC 16 also needs channel quality information for non-serving sectors to accurately predict throughputs for RBSs 14 in a candidate set. Thus, as described before, one solution is to transmit serving sector CQI information from the mobile stations 22 half as frequently (400 Hz versus 800 Hz) and use the remaining bandwidth to broadcast channel quality information for the other sectors in the mobile stations' candidate sets. Those skilled in the art will comprehend other possible solutions, including for example, multiplexing the channel quality information on the R-PDCH.

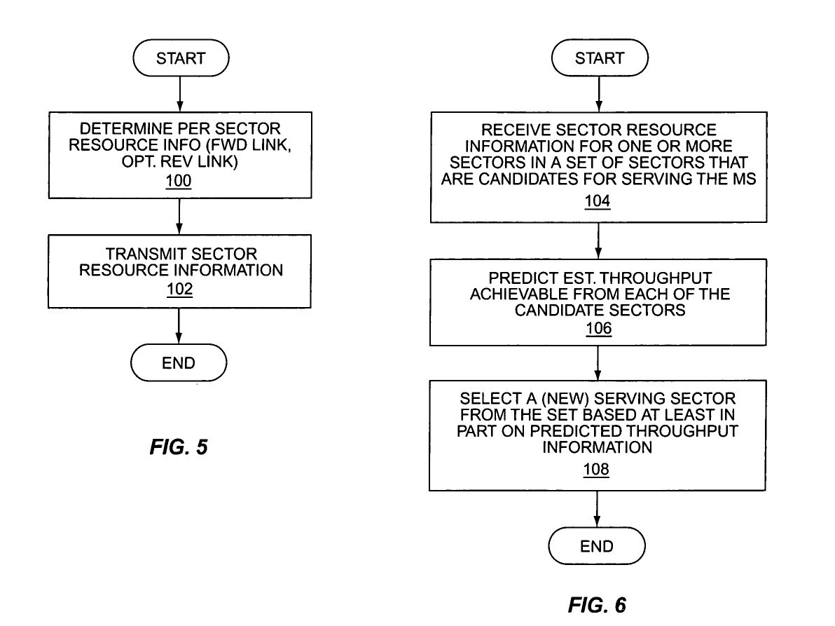

FIG. 5 broadly illustrates exemplary processing performed by the resource preprocessing circuit 54, and more generally, RBS 14 in accordance with the present invention. According to the illustrated processing logic, the RBS 14 determines per sector resource information (forward link and/or reverse link estimates) (Step 100), and transmits such information in one or more of its sectors, for use by mobile stations 22 operating in those sectors, and/or considering one or more of those sectors as possible candidates for serving sector selection (Step 102). Alternatively, RBS 14 may transmit the sector resource information upstream to RBS 16 for prediction, evaluation, and selection processing.

FIG. 6 broadly illustrates exemplary prediction, evaluation and selection processing as performed by throughput prediction circuit 46 and sector selection circuit 64 of mobile station 22. Alternatively, the illustrated processing may be performed by the prediction circuit 44 and sector selection circuit 24 of BSC 16. In either case, prediction circuit 46, 44 receives sector resource information for one or more of the network sectors that are candidates for serving a mobile station 22 (Step 104). The prediction circuit 46, 44 may receive information for all candidate sectors, e.g., all sectors in a mobile station 22 active set, or from fewer than all such sectors. In any case, the prediction circuit 46, 44 predicts an estimated throughput achievable from each sector if the mobile station 22 was actually served by that sector (Step 106). The sector selection circuit 64, 24 evaluates and compares the predicted throughputs and selects a non-serving sector if a significant improvement is possible elsewhere (Step 108). By way of non-limiting example, a mobile station 22 may select a new serving sector if the predicted throughput of a non-serving sector is higher for both the F-PDCH and the R-PDCH than that of the current serving sector by a predetermined amount.

In any case, the present invention, as illustrated by the above exemplary embodiments, comprises a method and apparatus providing continuous load balancing in a wireless communication network by enabling mobile stations desiring high-rate packet data services to select the best sector for that service in consideration of predicted throughputs for sectors in a candidate set. By influencing the autonomous sector selection processing of mobile stations as a function of per-sector throughput levels, or by the network making the sector selection decisions based on predicted throughputs, the network relieves localized congestion problems that might otherwise develop. It should be understood, then, that the present invention is not limited by the foregoing discussion, but rather by the following claims and their reasonable legal equivalents.

1. A method of selecting a serving sector for a mobile station in a wireless communication network for packet data service comprising:
predicting an expected throughput for each of a plurality of sectors in a candidate set;
evaluating the expected throughputs with respect to a current-sector throughput; and
conditionally selecting a new serving sector in the candidate set having a highest throughput as the serving sector.

2. The method of claim 1 wherein evaluating the expected throughputs with respect to a current-sector throughput comprises comparing the expected throughputs as predicted for one or more non-serving sectors in the candidate set to an actual throughput for the current serving sector.

3. The method of claim 1 wherein evaluating the expected throughputs with respect to a current-sector throughput comprises comparing the expected throughputs as predicted for one or more non-serving sectors in the candidate set to an expected throughput as predicted for the current serving sector.

4. The method of claim 1 wherein conditionally selecting a new serving sector in the candidate set having a highest throughput as the serving sector comprises selecting a new serving sector other than the current serving sector if the predicted throughput for the new serving sector exceeds the throughput of the current serving sector by a predetermined amount.

5. The method of claim 1 wherein predicting an expected throughput for each of the plurality of sectors in the candidate set comprises evaluating channel power, quality, and coding information for each of the plurality of sectors in the candidate set.

6. The method of claim 1 wherein predicting an expected throughput for each of the plurality of sectors in the candidate set comprises evaluating parameters relating at least partly to channel power, quality, and coding information for each of the plurality of sectors in the candidate set.

7. The method of claim 1 wherein predicting an expected throughput for each of the plurality of sectors in the candidate set comprises accounting for an attenuation of throughput that would arise by serving the mobile station from that sector.

8. The method of claim 1 wherein predicting an expected throughput for each of the plurality of sectors in the candidate set is performed by the mobile station.

9. The method of claim 8 further comprising transmitting channel power and coding information from each sector in the candidate set to the mobile station.

10. The method of claim 1 wherein predicting an expected throughput for each of the plurality of sectors in the candidate set is performed by the base station.

11. The method of claim 10 further comprising transmitting channel power and coding information from each sector in the candidate set to the base station and transmitting channel quality information from the mobile station to the base station.

12. The method of claim 1, further comprising adjusting one or more parameters of a throughput prediction algorithm used in said step of predicting an expected throughput for each of a plurality of sectors in a candidate set based on comparing an expected throughput as predicted for the mobile station's current serving sector to an actual throughput as measured for the current serving sector.

13. A mobile station comprising:
radio frequency transceiver circuits configured to send signals to and to receive signals from a wireless communication network; and
one or more processor circuits operatively associated with the radio frequency transceiver circuits and configured to predict a throughput for sectors among a set of sectors in the network that are candidates for serving the mobile station on a packet data channel.

14. The mobile station of claim 13 wherein the one or more processor circuits are adapted to predict the throughputs for one or more sectors in the set based on per-sector power and coding information received by the mobile station from the network, and based on per-sector channel quality measurements made by the mobile station for one or more of the candidate sectors.

15. The mobile station of claim 13 wherein the mobile station is configured to select a new serving sector by comparatively evaluating the predicted throughput and sector signal quality for two or more of the sectors in the set.

16. The mobile station of claim 15 wherein the mobile station is configured to select a new serving sector if the predicted throughput for the new serving sector is higher than the predicted throughput for a current serving sector by a predetermined amount.

17. The mobile station of claim 16 wherein the mobile station is configured to select a new serving sector if the predicted throughput for the new serving sector is higher than the predicted throughput for the current serving sector in both a forward and a reverse link packet data channel.

18. A method of serving sector selection by a mobile station comprising:
receiving shared packet data service at the mobile station from a current serving sector that is in a set of sectors that are serving sector candidates;
receiving sector resource information for one or more of the sectors in the set;
computing signal quality measurements for one or more of the sectors in the set; and
determining whether to change from a current serving sector to a new serving sector based on predicting estimated throughputs for each of the one or more sectors in the set based on evaluating the signal quality measurements and the sector resource information.

19. The method of claim 18 further comprising changing from the current serving sector to the new serving sector upon determining that the predicted throughput for the new serving sector is higher than the predicted throughput of the current serving sector.

20. The method of claim 19 wherein the throughput is predicted for a forward link packet data channel.

21. The method of claim 19 wherein the throughput is predicted for a reverse link packet data channel.

22. The method of claim 19 wherein the throughput is predicted for a forward link packet data channel and a reverse link packet data channel.

23. The method of claim 19 wherein changing from the current serving sector to the new serving sector comprises changing upon determining that the predicted throughput for the new serving sector is higher than the predicted throughput of the current serving sector by a defined margin.

24. The method of claim 18 wherein receiving sector resource information for one or more of the sectors in the set comprises receiving power, coding, and scheduling information from the one or more of the sectors in the set.

25. The method of claim 18 wherein receiving sector resource information for one or more of the sectors in the set comprises receiving parameters relating at least partly to power, coding, and scheduling information from the one or more of the sectors in the set.

26. A sectorized base station system comprising:
one or more sector resource processing circuits configured to calculate sector resource information in support of processing for predicting a sector to mobile station throughput on a packet data channel for one or more sectors of the base station system; and
one or more transceiver circuits configured to transmit the sector resource information.

27. The base station system of claim 26 wherein the transceiver circuits transmit the sector resource information to a base station controller.

28. The base station system of claim 26 wherein the transceiver circuits transmit the sector resource information in the corresponding sectors of the base station.

29. The base station system of claim 26 wherein the base station system includes a radio base station, and wherein the one or more sector resource processing circuits and the one or more transmitter circuits comprise radio base station circuits.

30. The base station system of claim 26 further comprising one or more throughput prediction circuits operatively associated with the resource processing circuits and configured to predict a throughput for sectors among a set of sectors in the base station system that are candidates for serving a mobile station on the packet data channel.

31. The base station system of claim 30 wherein the throughput prediction circuits predict a throughput for sectors among a set of sectors in the base station system using sector resource information received from the resource processing circuits and channel quality information received from the mobile station via the transceiver circuits.

32. The base station system of claim 31 wherein the base station system includes a base station controller and a radio base station, and wherein the base station controller further comprises sector selection circuits to select a new serving sector by comparatively evaluating the predicted throughput and channel quality information for two or more of the sectors in the set that are candidates for serving the mobile station on the packet data channel.

33. The base station system of claim 30 wherein the base station system includes a base station controller and a radio base station, and wherein the one or more throughput prediction circuits comprise radio base station circuits.

34. The base station system of claim 30 wherein the base station system includes a base station controller and a radio base station, and wherein the one or more throughput prediction circuits comprise base station controller circuits.

35. The base station system of claim 26 wherein the sector resource information comprises parameters relating to channel power, channel coding, and scheduler configuration.

36. The base station system of claim 26, wherein the base station system is configured to transmit a shared forward link packet data channel signal and an associated forward link packet data control channel signal in each sector of the base station system, and is further configured to provide the sector resource information on the forward link packet data control channel signal being transmitted in each sector.

37. The base station system of claim 36, wherein the base station system is configured to transmit the sector resource information periodically in each sector.

38. The base station system of claim 26, wherein the sector resource information comprises forward link sector resource information.

39. The base station system of claim 26, wherein the sector resource information further comprises reverse link sector resource information.
